(19) United States
(12) Patent Application Publication
(10) Pub. No.: US 2013/0095387 A1
(43) Pub. Date: Apr. 18, 2013

(54) CERAMIC MATERIAL AS WELL AS BATTERY ELECTRODE AND LITHIUM ION SECONDARY BATTERY CONTAINING THE SAME

(71) Applicant: TAIYO YUDEN CO., LTD., Tokyo (JP)

(72) Inventors: Chie KAWAMURA, Takasaki-shi (JP); Masaki MOCHIGI, Takasaki-shi (JP); Daigo ITO, Takasaki-shi (JP); Akitoshi WAGAWA, Takasaki-shi (JP); Yoichiro OGATA, Takasaki-shi (JP); Toshiyuki OCHIAI, Takasaki-shi (JP); Isao TAKAHASHI, Takasaki-shi (JP); Toshimasa SUZUKI, Takasaki-shi (JP)

(73) Assignee: TAIYO YUDEN CO., LTD., Tokyo (JP)

(21) Appl. No.: 13/625,681

(22) Filed: Sep. 24, 2012

(30) Foreign Application Priority Data
Oct. 12, 2011 (JP) 2011-225158

(51) Int. Cl. H01M 4/485

(52) U.S. Cl. 429/231.1; 252/182.1

(57) ABSTRACT

A ceramic material offering both high capacity and high rate characteristics includes, as a main constituent, titanium oxide, and 0.004 to 0.249 percent by mass of potassium, 0.013 to 0.240 percent by mass of phosphorous and 0.021 to 1.049 percent by mass of niobium, has a spinel structure, and preferably has a peak intensity measured on the Li_{27.84}Ti_{36.816}Nb_{1.344}O₉₀ (310) plane by powder X-ray diffraction corresponding to 3/10 of the peak intensity of the Li₄Ti₅O₁₂ (111) plane or less, or preferably has a maximum primary particle size of 2 μm or less. The ceramic material is used in an electrode which is used in a lithium ion secondary battery.

### BACKGROUND

1. Field of the Invention

The present invention relates to a lithium ion secondary battery, an electrode thereof, and a ceramic material whose main constituent is lithium titanate suitable as the material of such electrode.

2. Description of the Related Art

Lithium titanates having a spinel structure such as Li₄Ti₅O₁₂ undergo little volume change and are highly safe. Lithium ion secondary batteries using these lithium titanates for their negative electrode are beginning to be used in automotive and infrastructure applications. However, the market is demanding significant reduction of battery cost. Carbon materials are generally used to make negative electrodes and, although their safety is inferior to lithium titanates, carbon materials offer high capacity and are much cheaper than lithium titanates. Accordingly, it is important to maintain the high performance of lithium titanates and still increase the efficiency of their manufacturing process. The performances (electrochemical characteristics) required of lithium titanates include high capacity, high rate characteristics (high-speed charge/discharge) and long life.

Known methods to synthesize lithium titanates include the wet method and solid phase method. The wet method provides fine particles of high crystalline property and, among the various types of wet methods, the sol-gel method allows for uniform solution of those elements that are otherwise difficult to convert into solid solution or available only in trace amounts. However, the wet method as a whole presents many economic and environmental challenges because the materials used are expensive, processes are complex, and large amounts of effluent must be treated. The solid phase method is advantageous in terms of mass production because the materials used are less expensive and readily available and processes are simple. Accordingly, it is proposed to use the solid phase method by adding trace elements to obtain lithium titanate particles offering good characteristics.

Patent Literature 1 discloses a lithium titanate as an active material used for lithium secondary batteries demonstrating excellent charge/discharge characteristics, wherein such lithium titanate has a K₂O content of 0.10 to 0.25 percent by mass and P₂O₅ content of 0.10 to 0.50 percent by mass and is mainly constituted by Li₄Ti₅O₁₂.

Non-patent Literatures 1 and 2 report that by adding Nb to obtain Li₄Ti_{4.95}Nb_{0.05}O₁₂, good rate characteristics can be achieved. Non-patent Literature 3 reports that the rate characteristics of Li₄Ti₅₋ₓNbₓO₁₂ improve when X is 0.05 to 0.1, but its capacity gradually decreases when X becomes 0.15 or greater.

The technologies described in Non-patent Literatures 1 and 2 use the sol-gel method, while the technology described in Non-patent Literature 3 adopts a wet-type manufacturing method offering an advantage in terms of uniform solution of trace elements, where alkoxide is used as the material.

### BACKGROUND ART LITERATURES

[Patent Literature 1] Japanese Patent No. 4558229

[Non-patent Literature 1] B. Tian, et al., Niobium doped lithium titanate as a high rate anode material for Li-ion batteries, Electochim. Acta (2010)

[Non-patent Literature 2] Doi: 10.1016/j.electacta.2010.04.068

[Non-patent Literature 3] Yoshikawa, et al., “Structure and Electrode Characteristics of Lithium-excess Li4Ti5-xNbxO12 Synthesized by Spray Dry Method (in Japanese),” Proceedings of the Meeting of the Electrochemical Society of Japan, April 2010, p. 78, 1C34

### SUMMARY

If potassium (K) or phosphorous (P) is contained in a lithium titanate, cross-necking of particles progresses to promote the growth and cohesion of lithium titanate particles. As lithium titanate particles grow, rate characteristics drop, which presents a problem. Also, strong cohesion means that strong crush energy is needed when creating paste, and because the electrode sheet becomes less smooth, the separator may be damaged and the battery may undergo short-circuiting.

In consideration of the above, an object of the present invention is to provide a lithium titanate that can be manufactured by the solid phase method associated with low manufacturing cost and achieve both high capacity and high rate characteristics, as well as an electrode and a lithium ion secondary battery using such lithium titanate.

Any discussion of problems and solutions involved in the related art has been included in this disclosure solely for the purposes of providing a context for the present invention, and should not be taken as an admission that any or all of the discussion were known at the time the invention was made.

According to the new insight gained by the inventors of the present invention, adding niobium (Nb) to achieve X of approx. 0.05 in Li₄Ti₅₋ₓNbₓO₁₂ under the solid phase method improves rate characteristics, but reduces the capacity due to production of a secondary phase (Li_{27.84}Ti_{36.816}Nb_{1.344}O₉₀) as a result of insufficient solution of Nb in lithium titanate. However, it was found that coexistence of K and P would promote the solution of Nb even under the solid phase method and also suppress cross-necking (interparticle bonding) of particles due to the effect of added Nb, thereby suppressing the growth of lithium titanate particles and making them less likely to cohere. Based on this insight, the inventors of the present invention studied further in detail, primarily in the area of additive amounts of K, P and Nb, and finally completed the present invention.

The ceramic material proposed by the present invention contains 0.004 to 0.249 percent by mass of potassium, 0.013 to 0.240 percent by mass of phosphorous and 0.021 to 1.049 percent by mass of niobium, where preferably the peak intensity measured on the Li_{27.84}Ti_{36.816}Nb_{1.344}O₉₀ (310) plane by powder X-ray diffraction using a Cu target is 3/100 of the peak intensity of the Li₄Ti₅O₁₂ (111) plane or less, and also preferably the maximum size of the primary particle is 2 μm or less.

According to another embodiment of the present invention, a positive electrode for a battery or negative electrode for a battery is provided that contains the above ceramic material as its active material.

According to yet another embodiment of the present invention, a lithium ion secondary battery having such positive electrode or negative electrode is provided.

According to the present invention, a lithium titanate that does not easily undergo necking even when manufactured by the solid phase method and does not produce the secondary phase of Li_{27.84}Ti_{36.816}Nb_{1.344}O₉₀ is provided. This lithium titanate is subject to little necking and therefore tends to achieve smooth coating film, which is favorable for the material for battery electrodes. A lithium ion secondary battery whose electrodes contain the lithium titanate proposed by the present invention can achieve both high capacity and high rate characteristics.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a schematic section view of a half cell.

FIG. 2 is a schematic section view of a full cell.

### DESCRIPTION OF THE SYMBOLS

1 Al lead

2 Thermo-compression bonding tape

3 Kapton tape

4 Aluminum foil

5, 15, 16 Electrode mixture

6 Metal Li plate

7 Ni mesh

8 Ni lead

9 Separator

10 Aluminum laminate

### DETAILED DESCRIPTION OF EMBODIMENTS

According to the present invention, a ceramic material containing specified amounts of potassium, phosphorous and niobium is provided. The main constituent of this ceramic material is a lithium titanate having a spinel structure represented by Li₄Ti₅O₁₂, where this lithium titanate accounts for at least 90%, or preferably 95%, of the ceramic material proposed by the present invention. Preferably the lithium titanium accounts for all of the ceramic material excluding the trace constituents described later and unavoidable impurities. In this Specification, such ceramic material is sometimes referred to as simply “lithium titanate.” In other words, the ceramic material proposed by the present invention (lithium titanate) is a “lithium-titanium complex oxide.”

According to the present invention, the form of ceramic material is not specifically limited and the ceramic material, which is typically in a fine particle form, may also assume any other shape or form, such as that of an inorganic constituent contained in a paste into which a resin (binder) is mixed, or molding produced by drying such paste.

Trace constituents contained in the lithium titanate include potassium, phosphorous and niobium. If the mass of the ceramic material is 100%, the content of potassium is 0.004 to 0.249 percent by mass, or preferably 0.012 to 0.191 percent by mass, or more preferably 0.042 to 0.174 percent by mass. The content of phosphorous is 0.013 to 0.240 percent by mass, or preferably 0.022 to 0.175 percent by mass, or more preferably 0.031 to 0.144 percent by mass. The content of niobium is 0.021 to 1.049 percent by mass, or preferably 0.035 to 0.699 percent by mass, or more preferably 0.042 to 0.280 percent by mass. Preferably these trace constituents are all virtually dissolved in the ceramic structure of the lithium titanate as oxides. Presence of potassium and phosphorous makes it easy for niobium to be taken in, and as niobium is taken in, necking of the lithium titanate is suppressed and its rate characteristics improve. As a result, the lithium titanate offering high capacity, high rate characteristics, fine particles, and smooth coating film can be manufactured with ease even when the solid phase method is used.

Preferably the lithium titanate is in a fine particle form where the maximum size of its primary particle is 2 μm or less, or more preferably 0.2 to 1.5 μm or less. The size of the primary particle is calculated as the Feret diameter using an electron microscope image, and the diameters of at least 300 particles are measured, of which the maximum value is obtained. The specific method to obtain the Feret diameter is explained in detail in the Examples section. As long as the maximum size of the primary particle is within the aforementioned range, smooth surface can be achieved more easily when the lithium titanate is applied to a support metal piece, etc., to form an electrode, and particle sizes within this range are also preferable as the rate characteristics of the formed battery will improve.

According to the present invention, the main crystalline system of the lithium titanate is a spinel structure. A lithium titanate having a spinel structure can be expressed by the composition formula Li₄Ti₅O₁₂ and confirmed by the presence of specific peaks by X-ray diffraction as explained later. Li_{27.84}Ti_{36.816}Nb_{1.344}O₉₀, which is a secondary phase, may coexist in the lithium titanate. Preferably there is less of this secondary phase for improving the capacity of the formed battery. Preferably the peak intensity measured on the Li_{27.84}Ti_{36.816}Nb_{1.344}O₉₀ (310) plane by powder X-ray diffraction using a Cu target is 3/100 of the peak intensity of the Li₄Ti₅O₁₂ (111) plane or less. By adjusting the peak intensity ratio to such range, a more favorable initial discharge capacity can be achieved.

Under the solid phase method, lithium titanate is typically obtained by mixing and sintering a titanium compound, lithium compound, and trace constituents. For the titanium source, a titanium oxide is typically used. The particle size of lithium titanate is affected by the particle size of titanium oxide. Accordingly, use of a fine titanium oxide tends to produce a fine lithium titanate. On the other hand, preferably the specific surface area of the titanium oxide is in a range of 8 to 30 m²/g in order to avoid cohesion, which in turn will require more energy for mixing. For the lithium source, a carbonate, acetate or hydroxide is typically used. If a lithium hydroxide is used, it may be a hydrate such as monohydrate or the like. For the lithium source, two or more of the foregoing may be combined. Preferably a lithium source is mixed while being crushed and made finer to a maximum particle size of 10 μm or less, or a lithium source having a small maximum particle size is used from the beginning, as it would lower the lithium titanate production temperature, which is favorable when manufacturing a fine lithium titanate. It should be noted that, since lithium may decrease as a result of partial volatilization, loss due to sticking to equipment walls or for other reasons in the manufacturing process, it is preferable to use a greater amount of lithium source than the final target amount of Li.

It should be noted that, as mentioned above, Li may decrease as a result of volatilization, loss due to sticking to equipment walls, or for other reasons, during the manufacturing process. The ratio of lithium source and titanium source used as the materials should be determined by considering this decrease in Li. To get an idea on the level of decrease in Li, the results of examples explained later can be used as reference. These data can be used to easily determine the amount of source lithium to be added.

For the potassium source, a carbonate, hydrogen carbonate, or hydroxide is typically used, among others.

For the phosphorous source, an ammonium phosphate, etc., can be used. By using a potassium dihydrogen phosphate, dipotassium hydrogenphosphate, tripotassium phosphate or other substance containing both potassium and phosphorous, the potassium source and lithium source can be satisfied by only one compound.

For the niobium source, a niobium oxide is typically used. To promote reaction in a uniform manner, use of a fine powder of 200 nm or less in average primary particle size is recommended.

According to the present invention, the obtained ceramic material contains potassium, phosphorous and niobium at a specified ratio. These elements may be added to the materials in the forms of potassium, phosphorous and niobium oxides, respectively, or potassium, phosphorous and niobium may be compounded with other elements (such as lithium or titanium compound).

According to the present invention, a high-quality lithium titanate can be obtained using the solid phase method.

Under the solid phase method, the aforementioned materials are weighed and then mixed and sintered. The mixing process may be wet mixing or dry mixing. Wet mixing is a method whereby dispersion medium such as water, ethanol or the likeis used together with a ball mill, planetary ball mill, bead mill, wet jet mill, etc. Dry mixing is a method whereby no dispersion medium is used and a ball mill, planetary ball mill, bead mill, jet mill or flow-type mixer, or Nobilta (Hosokawa Micron), Miralo (Nara Machinery) or other machine capable of applying compressive force or shearing force to achieve precision mixing or efficiently add mechano-chemical effect, is used, among others.

In the case of dry mixing, water or organic solvent can be used as a mixing auxiliary. For the organic solvent, alcohol, ketone, etc., can be used. Examples of the alcohol include methanol, ethanol, propanol, butanol, ethylene glycol, propylene glycol, diethylene glycol, triethylene glycol, dipropylene glycol, tripropylene glycol, glycerin, and the like, while examples of the ketone include acetone, diethyl ketone, methyl ethyl ketone, methyl isobutyl ketone, acetyl acetone, cyclohexanone, and the like. Any one of the foregoing or mixture of two or more can be added by a trace amount to increase the efficiency of mixing.

In the case of wet mixing, load in the drying process can be reduced by minimizing the dispersion medium used. If the dispersion medium is too little, the slurry becomes highly viscous and may clog the piping or present other problems. Accordingly, preferably a small amount (approx. 5 percent by mass or less) of polyacrylate or similar dispersion medium is used, where desirably the solid content is adjusted to a range of 4.8 to 6.5 mol/L for Li material and 6 to 7.9 mol/L for titanium oxide at the time of mixing.

At the time of mixing, the order in which the dispersion medium (water, etc.), dispersant, Li material and titanium material are added does not affect the quality of the final product. For example, the dispersion medium, dispersant, Li material and titanium material can be added, in this order, under agitation using agitating blades. Or, the Li material and titanium material can be roughly mixed beforehand and then added in the last step, as it saves the mixing time and increases efficiency.

Whichever mixing method is used, if a carbonate is used for the Li source, it is preferable to mix the ingredients until the weight loss due to CO₂ dissociation caused by breakdown of lithium carbonate no longer occurs based on heat analysis measurement of the material mixed powder at 700° C. or below. In this case, the measurement conditions for heat analysis are as follows: Use a platinum container of 5 mm in diameter, 5 mm in height and 0.1 min in thickness, 15 mg of sample and Al₂O₃ as a standard sample; raise temperature at a rate of 5° C./min up to 850° C.; and introduce, as an ambient gas, a gas mixture consisting of 80% nitrogen and 20% oxygen, by the flow rate recommended for the heat analyzer. Any measurement system can be used, such as Thermo Plus TG8120 by Rigaku or TG-DTA2000S by Mac Science and the like, as these machines achieve similar results. If breakdown of lithium carbonate does not end at 700° C. or below, mixing should be continued until the thermal breakdown temperature becomes 700° C. or below. It is deemed that the lower the ending temperature of thermal breakdown of lithium carbonate, the more uniformly the titanium source and lithium carbonate are mixed, which in turn allows for a lower setting of sintering temperature and reduces the growth of lithium titanate particles. In addition, by mixing the ingredients until the thermal breakdown temperature of lithium carbonate becomes 700° C. or below, mixing of the trace amounts of potassium compound, phosphorous compound and niobium compound added will progress sufficiently.

For the sintering temperature after mixing, a typical condition is 700 to 1000° C., and a preferable condition is 700 to 900° C. The sintering time is preferably 12 hours or less, or more preferably 1 hour or less. If the sintering temperature is higher than necessary and sintering time is longer than necessary, the peak intensity ratio of the Li₄Ti₅O₁₂ (111) plane as measured by X-ray diffraction on the ceramic material will increase and the particle size will exceed the desired level. If the sintering temperature and sintering time are insufficient, on the other hand, the peak intensity ratio of the Li₄Ti₅O₁₂ (111) plane as measured by X-ray diffraction on the ceramic material will decrease and the battery capacity will drop.

The peak intensity ratio of the Li₄Ti₅O₁₂ (111) plane is calculated as follows:

Peak intensity ratio of Li₄Ti₅O₁₂ (111) plane=a/(a+b+c+d+e)×100

(a: Peak intensity of L i₄Ti₅O₁₂ (111) plane (2θ=18.331), b: Peak intensity of Li₂TiO₃ (−133) plane (2θ=48.583), c: Peak intensity of rutile TiO₂ (110) plane (2θ=27.447), d: Peak intensity of KTi₈O₁₆ (310) plane (2θ=27.610), e: Peak intensity of Li_{27.84}Ti_{36.816}Nb_{1.344}O₉₀ (018) plane (2θ=22.628))

By adjusting the peak intensity ratio of the Li₄Ti₅O₁₂ (111) plane to 90% or greater, or preferably 95% or greater, the initial discharge capacity can be increased. Also, by adjusting the maximum primary particle size to 2 μm or less, favorable smoothness of a sheet can be achieved when forming an electrode. In addition, preferably the sintering temperature and sintering time are adjusted as deemed appropriate so that the specific surface area becomes 3 to 11 m²/g, and by adjusting the specific surface area to this range, the secondary battery will express high rate characteristics.

There is no limitation on the sintering ambience, and sintering can be performed in atmosphere, oxygen atmosphere, or inert gas atmosphere, under either atmospheric pressure or decompression. Sintering can also be performed multiple times. Sintered powder may be crushed/classified or re-sintered, as necessary. Although the solid phase method discussed above is advantageous in terms of cost among the manufacturing methods for lithium titanate, the sol-gel method or wet method using alkoxide can also be adopted.

The lithium titanate proposed by the present invention can be used favorably as an active electrode material for lithium ion secondary batteries. It can be used for positive electrodes or negative electrodes. The configurations and manufacturing methods of electrodes containing the lithium titanate as their active material and lithium ion secondary battery having such electrodes can apply any prior technology as deemed appropriate. Also in the examples explained later, an example of manufacturing a lithium ion secondary battery is presented. Typically a suspension containing the lithium titanate as an active material, conductive auxiliary, binder and appropriate solvent is prepared and this suspension is applied to the metal piece of the collector, etc., and dried, and then pressed to form an electrode.

For the conductive auxiliary, metal powder such as carbon material, aluminum powder or the like, or conductive ceramics such as TiO or the likecan be used. Examples of the carbon material include acetylene black, carbon black, coke, carbon fiber and graphite.

Examples of the binder include various resins, or specifically fluororesins, etc., for example, polytetrafluoroethylene (PTFE), polyvinylidene difluoride (PVdF), fluororubber, styrene butadiene rubber, and the like.

Preferably the blending ratio of negative electrode active material, conductive agent, and binder is 80 to 98 percent by mass of negative electrode active material, 0 to 20 percent by mass of conductive agent, and 2 to 7 percent by mass of binder.

The collector is preferably an aluminum foil or aluminum alloy foil of 20 μm or less in thickness.

When the lithium titanate material is used as a negative electrode active material, the material used for the positive electrode is not specifically limited and any known material can be used, where examples include lithium-manganese complex oxide, lithium-nickel complex oxide, lithium-cobalt complex oxide, lithium-nickel-cobalt complex oxide, lithium-manganese-nickel complex oxide, spinel lithium-manganese-nickel complex oxide, lithium-manganese-cobalt complex oxide, and lithium iron phosphate, etc.

For the conductive agent, binder, and collector for the positive electrode, those mentioned above can be used. Preferably the blending ratio of positive electrode active material, conductive agent and binder is 80 to 95 percent by mass of positive electrode active material, 3 to 20 percent by mass of conductive agent and 2 to 7 percent by mass of binder.

From the positive/negative electrodes thus obtained, electrolyte solution constituted by lithium salt and organic solvent or organic solid electrolyte or inorganic solid electrolyte, separator, etc., a lithium ion secondary battery can be constituted.

Examples of the lithium salt include lithium perchlorate (LiClO₄), lithium hexafluorophosphate (LiPF₆), lithium tetrafluoroborate (LiBF₄), lithium hexafluoroarsenate (LiAsF₆), lithium trifluorometanesulfonate (LiCF₃SO₃), lithium bis-trifluoromethyl sulfonyl imide [LiN(CF₃SO₂)₂], and the like. One type of lithium salt may be used, or two or more types may be combined. Examples of the organic solvent include propylene carbonate (PC), ethylene carbonate (EC), vinylene carbonate and other cyclic carbonates; diethyl carbonate (DEC), dimethyl carbonate (DMC), methyl ethyl carbonate (MEC) and other chained carbonates; tetrahydrofuran (THF), 2-methyl tetrahydrofuran (2MeTHF), dioxolane (DOX) and other cyclic ethers; dimethoxy ethane (DME), dietoethan (DEE) and other chained ethers; y-butyrolactone (GBL); acetonitrile (AN); and sulfolane (SL), etc., either used alone or combined into a mixed solvent.

For the organic solid electrolyte, polyethylene derivative, polyethylene oxide derivative or polymer compound containing it, or polypropylene oxide derivative or polymer compound containing it, is suitable, for example. Among the inorganic solid electrolytes, Li nitride, halogenated Li and Li oxyate are well-known. In particular, Li₄SiO₄, Li₄SiO₄—LiI—LiOH, xLi₃PO₄-(1−x) Li₄SiO₄, Li₂SiS₃, Li₃PO₄—Li₂S—SiS₂, phosphorus sulfide compound, etc., are effective.

For the separator, a polyethylene microporous membrane is used. The separator is installed between the two electrodes in a manner not allowing the positive electrode and negative electrode to contact each other.

### EXAMPLES

The present invention is explained more specifically using examples below. It should be noted, however, that the present invention is not limited to the embodiments described in these examples. For example, the methods for adding the trace constituents K, P and Nb are not limited to those described in the examples, and they can be added in any way as long as their final mass percents match. First, how the samples obtained by the examples/comparative examples were analyzed and evaluated is explained.

(Element Analysis)

A sample of the ceramic material was broken down by acid and then elements contained in the sample were quantified using atomic absorption spectrochemical analysis or ICP emission spectrochemical analysis. The ratios of existence (%) of potassium, phosphorous and niobium as elements were calculated based on the weight of the ceramic material being 100%.

(Powder X-Ray Diffraction)

Measurement was performed using powder XRD (Ultima IV by Rigaku, target Cu, acceleration voltage 40 kV, discharge current 40 mA, divergence slit width 1°, divergence longitudinal slit width 10 mm). The peak intensity ratio of each compound was expressed by the peak intensity of the applicable compound based on the peak intensity of the Li₄Ti₅O₁₂ (111) plane (2θ=18.331) being 100. To be specific, for the compounds to be detected, peak intensities of the Li₂TiO₃ (−133) plane (2θ=48.583), rutile TiO₂ (110) plane (2θ=27.447), KTi₈O₁₆ (310) plane (2θ=27.610) and Li_{27.84}Ti_{36.816}Nb_{1.344}O₉₀ (018) plane (2θ=22.628) were calculated. The value of each 2θ was taken from the JCPDS card.

(Particle Size Measurement—SEM Observation)

The maximum primary size of the lithium titanate particle was measured using a ×30,000 photograph taken by a scanning electron microscope (SEM, 54800 by Hitachi). The photograph was captured at a screen size of 7.3 cm×9.5 cm, and the Feret diameter was measured for all particles on the photograph, of which the maximum value was taken as the maximum primary size. If less than 300 particles were measured, multiple SEM photographs were taken with different fields of view until at least 300 particles were measured. The Feret diameter is a tangential diameter in a fixed direction, defined by the distance between two parallel tangential lines sandwiching a particle (Society of Powder Technology, Japan, ed., “Particle Measurement Technology (in Japanese),” Nikkan Kogyo Shimbun, P. 7 (1994)).

(Battery Evaluation—Half Cell)

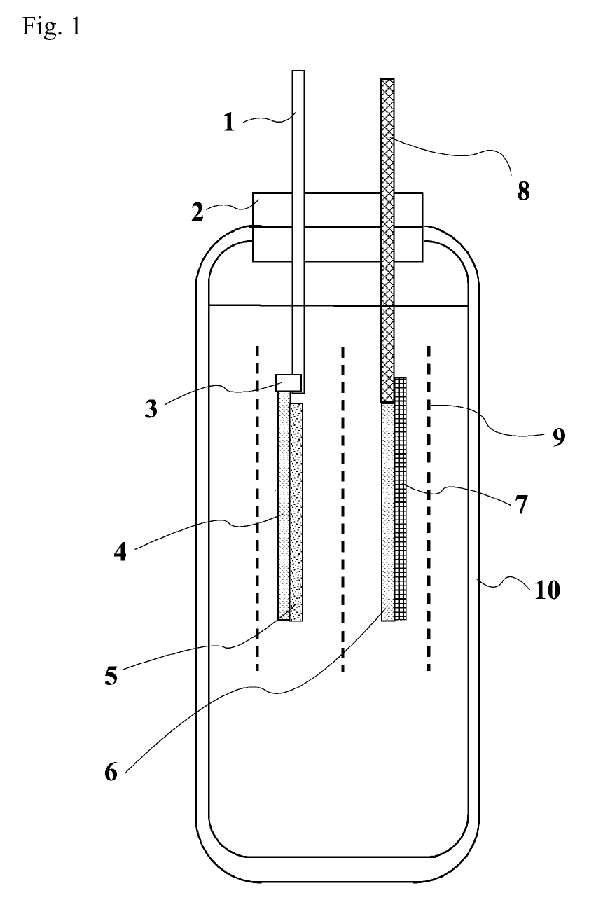

FIG. 1 is a schematic section view of a half cell. With this cell, lithium metal is used for the counter electrode, so the potential of the electrode shown is nobler than that of the counter electrode. Accordingly, the directions of charge/discharge are the opposite of those applicable when lithium titanate is used for the negative electrode. To avoid confusion, the direction in which lithium ions are inserted into the lithium titanate electrode is called “charge,” while the direction in which lithium ions dissociate from the electrode is called “discharge.” An electrode mixture was prepared using lithium titanate as an active material. Ninety parts by weight of the obtained lithium titanate as an active material, 5 parts by weight of acetylene black as a conductive auxiliary, and 5 parts by weight of fluororesin as a binder, were mixed using n-methyl-2-pyrrolidon as a solvent. This electrode mixture 5 was applied to an aluminum foil 4 to a coating weight of 0.003 g/cm² using the doctor blade method. The coated foil was vacuum-dried at 130° C., and then roll-pressed. Thereafter, an area of 10 cm² was stamped out from the pressed foil to obtain a working electrode of a battery. For the counter electrode, a metal Li plate 6 attached to a Ni mesh 7 was used. For the electrolyte solution, ethylene carbonate and diethyl carbonate were mixed at a volume ratio of 1:2, and then 1 mol/L of LiPF₆ was dissolved into the obtained solvent. For a separator 9, a porous cellulose membrane was used. Also, as illustrated, Al leads 1, 8 were fixed using a thermo-compression bonding tape 2, and the Al lead 1 was fixed to the working electrode using a Kapton tape 3. An aluminum laminate cell 10 was thus prepared. This battery was used to measure the initial discharge capacity. The battery was charged to 1.0 V at a constant current of 0.105 mA/cm² (0.2 C) in current density, and then discharged to 3.0 V, with the cycle repeated three times and the discharge capacity in the third cycle used as the value of initial discharge capacity. Preferably the initial discharge capacity is 155 mAh/g or more. Next, the rate characteristics were measured. The battery was charged to 1.0 V at a constant current of 0.525 mA/cm² in current density, and then discharged to 3.0 V, with the cycle repeated twice and similar measurements performed by increasing the current density in steps to 1.05 mA/cm², 1.575 mA/cm², 2.626 mA/cm^{2b , 5.25} mA/cm², and 8 mA/cm². The ratio of the discharge capacity in the second cycle at a current density of 8 mA/cm², and the value of initial discharge capacity, was indicated as the rate characteristics (%). Preferably the rate characteristics are 60% or more.

(Battery Evaluation—Full Cell)

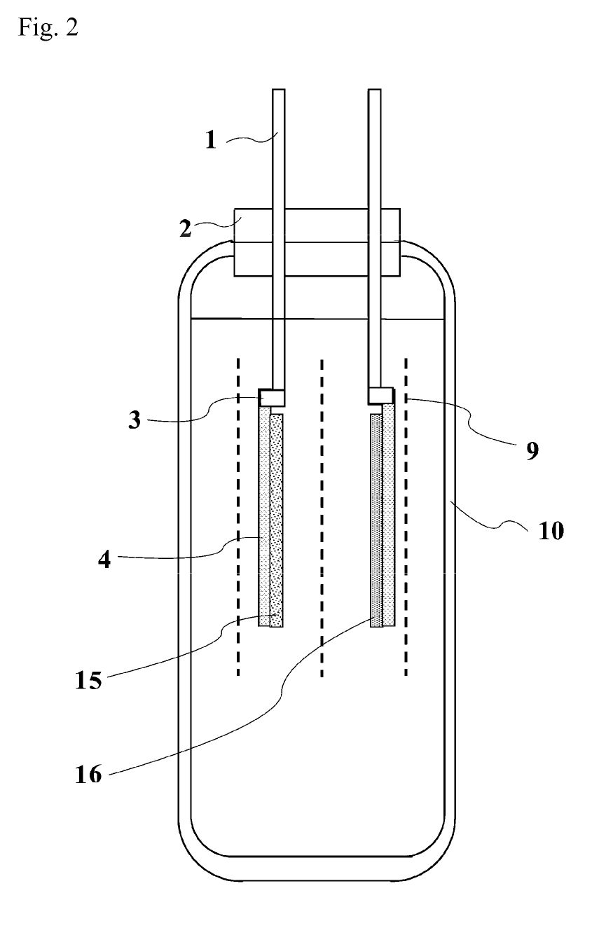

FIG. 2 is a schematic section view of a full cell. A negative electrode mixture 15 was prepared using the obtained lithium titanate as an active material. To be specific, a negative electrode using the obtained lithium titanate as its active material was manufactured in the same manner as the working electrode of the half cell mentioned above. A positive electrode mixture 16 was obtained by mixing 90 parts by weight of lithium cobaltate as an active material (D50%=10 μm), 5 parts by weight of acetylene black as a conductive auxiliary, and 5 parts by weight of fluororesin as a binder, together with n-methyl-2-pyrrolidone as a solvent. This electrode mixture was applied to an aluminum foil to a coating weight of 0.0042 g/cm² using the doctor blade method. The coated foil was vacuum-dried at 130° C., and then roll-pressed to obtain a positive electrode. The electrolyte solution and separator 9 conformed to those of the half cell mentioned above. An aluminum laminate cell was thus prepared. This battery was used to measure the initial discharge capacity. The battery was charged to 2.8 V at a constant current of 0.105 mA/cm² (0.2 C) in current density, and then discharged to 1.5 V, with the cycle repeated three times and the discharge capacity in the third cycle used as the value of initial discharge capacity. Next, the rate characteristics were measured. The battery was charged to 1.5 V at a constant current of 0.525 mA/cm² in current density, and then discharged to 2.8 V, with the cycle repeated twice and similar measurements performed by increasing the current density in steps to 1.05 mA/cm², 1.575 mA/cm², 2.625 mA/cm², 5.25 mA/cm², and 8 mA/cm². The ratio of the discharge capacity in the second cycle at a current density of 8 mA/cm², and the value of initial discharge capacity, was indicated as the rate characteristics (%).

(Smoothness of Electrode Sheet)

The surface roughness Ra (JIS 2001) of the roll-pressed electrode sheet used in the battery manufacturing process above was measured using an AFM. Preferably the value of Ra is 300 nm or less. By adjusting the value of Ra within this range, a homogeneous electrode sheet having a smooth surface and preventing the applied electrode material from separating can be obtained.

### Example 1

A sample was manufactured as explained below so that the Li:Ti mol ratio of the product obtained after sintering became 4:5. A lithium carbonate (commercially available highly pure reagent of 99% purity) was used for the Li source, along with a highly pure titanium oxide product of 99.9% purity and 10±1 m²/g in specific surface area. The lithium carbonate and titanium oxide were mixed by the masses specified in Table 1, with 1000 g of pure water as a dispersion medium. As a dispersant, ammonium polyacrylate was added to a weight ratio of dispersion medium and titanium oxide of 1:130. When this input mixing ratio was determined, potential trace decrease in Li as a result of volatilization, loss due to sticking to equipment walls, etc., was considered, and therefore the mol ratio of Li and Ti to be input was set to 4.05:5. As trace additives, potassium hydroxide, ammonium dihydrogen phosphate and niobium oxide (all commercially available, highly pure reagents) were added by the quantities specified in Table 1 to obtain a slurry. This slurry was agitated and mixed in a bead mill using 1.5-mm ZrO₂ beads, after which the dispersion medium was removed using a spray dryer and the resulting mixture was heated for 3 hours in atmosphere at 820° C. to obtain a ceramic material (lithium titanate). The mol ratio of Li and Ti in the product obtained after sintering was 4:5 as a result of element analysis.

In this example, full-cell battery evaluation was also conducted in addition to measuring each of the data specified in Table 2 as explained later. As a result, the initial discharge capacity was 159 mAh/g and rate characteristics were 62%, equivalent to the corresponding values of the half cell.

### Example 2

A sample was prepared so that the Li:Ti mol ratio of the product obtained after sintering became 4:5. The same lithium carbonate and titanium oxide used in Example 1 were mixed by the masses specified in Table 1, and then potassium hydroxide, ammonium dihydrogen phosphate, and niobium oxide were added, also by the quantities specified in Table 1, with the mixture dry-mixed for 2 hours in a planetary ball mill using ZrO₂ balls of 10 mm in diameter, after which the mixture was heated for 3 hours in atmosphere at 850° C. to obtain a ceramic material (lithium titanate). (By considering potential trace decrease in Li as a result of volatilization, loss due to sticking to equipment walls, etc., the mol ratio of Li and Ti to be input was set to 4.05:5.) The mol ratio of Li and Ti in the product obtained after sintering was 4:5 as a result of element analysis.

### Example 3

A sample was prepared in the same manner as in Example 2, except that ethanol was added as a mixing auxiliary in the mixing process by 0.5 percent by mass relative to the total weight of powder. The mol ratio of Li and Ti in the product obtained after sintering was 4:5 as a result of element analysis.

### Examples 4 to 25

A ceramic material (lithium titanate) was obtained in the same manner as in Example 2, except that the materials were used by the quantities specified in Table 1. In these examples, the mol ratio of Li and Ti in the product obtained after sintering was 4:5 as a result of element analysis.

### Comparative Example 1

A ceramic material (lithium titanate) was obtained in the same manner as in Example 2, except that potassium hydroxide, ammonium dihydrogen phosphate and niobium oxide were not added.

In this comparative example, full-cell battery evaluation was also conducted in addition to measuring each of the data specified in Table 2 as explained later. As a result, the initial discharge capacity was 148 mAh/g and rate characteristics were 55%, equivalent to the corresponding values of the half cell.

### Comparative Examples 2 to 8

A ceramic material (lithium titanate) was obtained in the same manner as in Example 2, except that the materials were used by the quantities specified in Table 1.

The quantities of materials used as well as measurement and evaluation results are summarized in Tables 1 and 2.

In Table 2, the “Initial discharge capacity” and “Rate characteristics” fields indicate the results measured on the half cell described above. The “Smoothness of sheet” field indicates “x” when Ra was greater than 300 nm, “0” when Ra was between 250 and 300 nm, and “ [symbol] ” when Ra was smaller than 250 nm. The “Overall evaluation” field indicates “x” when the initial discharge capacity was smaller than 155 mAh/g, rate characteristics were smaller than 60%, or Ra was greater than 300 nm. “ [symbol] ” was given when the initial discharge capacity was 160 mAh/g or greater, rate characteristics were 65% or greater, and Ra was less than 250 nm. “O” was given when neither the condition for “×” nor “ [symbol] ” was applicable.

TABLE 1
Unit (g)

| | | | | Ammonium | Ni- |
|---|---|---|---|---|---|
| | Titanium | Lithium | Potassium | dihydrogen | obium |
| | oxide | carbonate | hydroxide | phosphate | oxide |
| Example 1 | 870.7130 | 329.1714 | 0.0730 | 0.5625 | 0.3368 |
| Example 2 | 870.7130 | 329.1714 | 0.0608 | 0.6783 | 15.3112 |
| Example 3 | 870.7130 | 329.1714 | 3.4655 | 0.6286 | 0.4083 |
| Example 4 | 870.7130 | 329.1714 | 0.0730 | 8.6026 | 0.4083 |
| Example 5 | 870.7130 | 329.1714 | 3.5506 | 0.6286 | 14.4946 |
| Example 6 | 870.7130 | 329.1714 | 0.0851 | 8.9500 | 13.8821 |
| Example 7 | 870.7130 | 329.1714 | 3.6357 | 9.0658 | 0.3879 |
| Example 8 | 870.7130 | 329.1714 | 3.5749 | 8.8672 | 14.1884 |
| Example 9 | 870.7130 | 329.1714 | 0.1824 | 0.8768 | 0.5104 |
| Example 10 | 870.7130 | 329.1714 | 0.2067 | 0.9761 | 10.0033 |
| Example 11 | 870.7130 | 329.1714 | 2.7359 | 0.8603 | 0.5104 |
| Example 12 | 870.7130 | 329.1714 | 0.1946 | 6.5677 | 0.5104 |
| Example 13 | 870.7130 | 329.1714 | 2.7602 | 0.9099 | 9.9012 |
| Example 14 | 870.7130 | 329.1714 | 0.1946 | 6.6173 | 10.0033 |
| Example 15 | 870.7130 | 329.1714 | 2.7724 | 6.4519 | 0.6124 |
| Example 16 | 870.7130 | 329.1714 | 2.6751 | 6.4519 | 10.1054 |
| Example 17 | 870.7130 | 329.1714 | 0.6201 | 1.2077 | 0.6124 |
| Example 18 | 870.7130 | 329.1714 | 0.6445 | 1.2242 | 4.0830 |
| Example 19 | 870.7130 | 329.1714 | 2.5292 | 1.1746 | 0.7145 |
| Example 20 | 870.7130 | 329.1714 | 0.6080 | 5.4097 | 0.6124 |
| Example 21 | 870.7130 | 329.1714 | 2.5414 | 1.1580 | 3.8788 |
| Example 22 | 870.7130 | 329.1714 | 0.6323 | 5.4593 | 3.9809 |
| Example 23 | 870.7130 | 329.1714 | 2.5170 | 5.4262 | 0.6124 |
| Example 24 | 870.7130 | 329.1714 | 2.5535 | 5.4428 | 3.7768 |
| Example 25 | 870.7130 | 329.1714 | 2.7967 | 4.2186 | 3.8788 |
| Comparative | 870.7130 | 329.1714 | 0.0000 | 0.0000 | 0.0000 |
| Example 1 | | | | | |
| Comparative | 870.7130 | 329.1714 | 0.0000 | 0.1654 | 16.3319 |
| Example 2 | | | | | |
| Comparative | 870.7130 | 329.1714 | 3.2466 | 0.3309 | 0.2041 |
| Example 3 | | | | | |
| Comparative | 870.7130 | 329.1714 | 0.0122 | 7.6099 | 0.1021 |
| Example 4 | | | | | |
| Comparative | 870.7130 | 329.1714 | 3.2223 | 0.1654 | 15.9236 |
| Example 5 | | | | | |
| Comparative | 870.7130 | 329.1714 | 0.0365 | 7.9574 | 16.5361 |
| Example 6 | | | | | |
| Comparative | 870.7130 | 329.1714 | 3.3196 | 7.3453 | 0.1021 |
| Example 7 | | | | | |
| Comparative | 870.7130 | 329.1714 | 2.9183 | 4.9630 | 0.0000 |
| Example 8 | | | | | |

TABLE 2

| | | | | | | Peak XRD intensity | |
|---|---|---|---|---|---|---|---|
| | | | | | | ratio of each | |
| | | | | | | compound based | |
| | | | | Initial | Rate | on Li₄Ti₅O₁₂ | |
| | Analysis results of | | | discharge | characteristics % | main peak (111) | |
| | ceramic material | | | capacity mAh/g | (ratio of 8 mA/cm⁻² | plane being 100 | |
| | K | P | Nb | (0.2 C, third | capacity and initial | Li₂TiO₃ | TiO₂ rutile |
| | (wt %) | (wt %) | (wt %) | cycle) | capacity) | (−133) | (110) |
| Example 1 | 0.005 | 0.015 | 0.023 | 160 | 63 | 2.2 | 0.6 |
| Example 2 | 0.004 | 0.018 | 1.049 | 157 | 73 | 1.9 | 0.6 |
| Example 3 | 0.237 | 0.017 | 0.028 | 164 | 63 | 1.9 | 0.8 |
| Example 4 | 0.005 | 0.227 | 0.028 | 160 | 61 | 2.2 | 1.0 |
| Example 5 | 0.242 | 0.017 | 0.993 | 161 | 72 | 1.8 | 0.5 |
| Example 6 | 0.006 | 0.236 | 0.951 | 160 | 74 | 2.0 | 0.8 |
| Example 7 | 0.248 | 0.239 | 0.027 | 168 | 62 | 1.7 | 0.5 |
| Example 8 | 0.244 | 0.234 | 0.972 | 163 | 75 | 1.8 | 0.6 |
| Example 9 | 0.012 | 0.023 | 0.035 | 163 | 68 | 2.1 | 0.8 |
| Example 10 | 0.014 | 0.026 | 0.685 | 159 | 72 | 1.9 | 0.7 |
| Example 11 | 0.187 | 0.023 | 0.035 | 164 | 64 | 1.8 | 0.8 |
| Example 12 | 0.013 | 0.173 | 0.035 | 160 | 62 | 2.0 | 0.9 |
| Example 13 | 0.188 | 0.024 | 0.678 | 164 | 72 | 1.8 | 0.7 |
| Example 14 | 0.013 | 0.175 | 0.685 | 160 | 73 | 2.2 | 0.9 |
| Example 15 | 0.189 | 0.170 | 0.042 | 165 | 66 | 1.9 | 0.7 |
| Example 16 | 0.183 | 0.170 | 0.692 | 164 | 70 | 1.8 | 0.8 |
| Example 17 | 0.042 | 0.032 | 0.042 | 165 | 65 | 2.1 | 0.9 |
| Example 18 | 0.044 | 0.032 | 0.280 | 160 | 71 | 1.8 | 1.0 |
| Example 19 | 0.173 | 0.031 | 0.049 | 167 | 65 | 2.0 | 0.8 |
| Example 20 | 0.042 | 0.143 | 0.042 | 167 | 66 | 2.1 | 0.9 |
| Example 21 | 0.174 | 0.031 | 0.266 | 164 | 72 | 1.7 | 0.8 |
| Example 22 | 0.043 | 0.144 | 0.273 | 165 | 69 | 2.1 | 1.1 |
| Example 23 | 0.172 | 0.143 | 0.042 | 169 | 62 | 2.0 | 0.7 |
| Example 24 | 0.174 | 0.144 | 0.259 | 163 | 71 | 1.7 | 0.6 |
| Example 25 | 0.191 | 0.111 | 0.266 | 170 | 70 | 1.8 | 0.7 |
| Comparative Example 1 | 0.000 | 0.000 | 0.000 | 149 | 55 | 2.6 | 1.4 |
| Comparative Example 2 | 0.000 | 0.004 | 1.118 | 140 | 65 | 2.2 | 1.0 |
| Comparative Example 3 | 0.222 | 0.009 | 0.014 | 164 | 37 | 2.0 | 0.9 |
| Comparative Example 4 | 0.001 | 0.201 | 0.007 | 148 | 58 | 2.5 | 1.8 |
| Comparative Example 5 | 0.220 | 0.004 | 1.091 | 148 | 67 | 2.1 | 1.1 |
| Comparative Example 6 | 0.002 | 0.210 | 1.132 | 145 | 66 | 2.4 | 1.3 |
| Comparative Example 7 | 0.227 | 0.194 | 0.007 | 164 | 38 | 1.9 | 1.2 |
| Comparative Example 8 | 0.199 | 0.131 | 0.000 | 165 | 35 | 1.8 | 0.9 |

| | Peak XRD intensity ratio of | | | | | |
|---|---|---|---|---|---|---|
| | each compound based on Li₄Ti₅O₁₂ | | | | | |
| | main peak (111) plane being 100 | | Maximum | | | |
| | KTi₈O₁₆ | Li_{27.84}Ti_{36.816}Nb_{1.344}O₉₀ | primary | Smoothness of sheet | | Overall |
| | (310) | (018) | size (μm) | Ra (nm) | Evaluation | evaluation |
| Example 1 | 0.0 | 0.0 | 1.5 | 180 | [symbol] | ◯ |
| Example 2 | 0.0 | 3.2 | 1.4 | 120 | [symbol] | ◯ |
| Example 3 | 0.8 | 0.0 | 1.8 | 270 | ◯ | ◯ |
| Example 4 | 0.0 | 0.0 | 1.7 | 220 | [symbol] | ◯ |
| Example 5 | 0.8 | 2.5 | 1.9 | 280 | ◯ | ◯ |
| Example 6 | 0.0 | 2.9 | 1.3 | 140 | [symbol] | ◯ |
| Example 7 | 0.8 | 0.1 | 2.2 | 280 | ◯ | ◯ |
| Example 8 | 0.9 | 2.5 | 1.7 | 230 | [symbol] | ◯ |
| Example 9 | 0.1 | 0.0 | 1.4 | 170 | [symbol] | ◯ |
| Example 10 | 0.1 | 1.4 | 1.3 | 110 | [symbol] | ◯ |
| Example 11 | 0.7 | 0.0 | 1.8 | 240 | [symbol] | ◯ |
| Example 12 | 0.1 | 0.0 | 1.6 | 200 | [symbol] | ◯ |
| Example 13 | 0.7 | 1.3 | 1.5 | 130 | [symbol] | ◯ |
| Example 14 | 0.1 | 1.5 | 1.4 | 110 | [symbol] | [symbol] |
| Example 15 | 0.7 | 0.0 | 1.8 | 250 | ◯ | ◯ |
| Example 16 | 0.7 | 1.7 | 1.6 | 160 | [symbol] | [symbol] |
| Example 17 | 0.1 | 0.0 | 1.5 | 140 | [symbol] | ◯ |
| Example 18 | 0.1 | 0.6 | 1.3 | 120 | [symbol] | ◯ |
| Example 19 | 0.6 | 0.0 | 1.7 | 200 | [symbol] | [symbol] |
| Example 20 | 0.1 | 0.0 | 1.6 | 200 | [symbol] | [symbol] |
| Example 21 | 0.6 | 0.5 | 1.5 | 150 | [symbol] | [symbol] |
| Example 22 | 0.1 | 0.5 | 1.4 | 170 | [symbol] | [symbol] |
| Example 23 | 0.6 | 0.1 | 1.7 | 190 | [symbol] | ◯ |
| Example 24 | 0.7 | 0.5 | 1.5 | 110 | [symbol] | ◯ |
| Example 25 | 0.7 | 0.3 | 1.2 | 90 | [symbol] | [symbol] |
| Comparative Example 1 | 0.0 | 0.0 | 1.8 | 200 | [symbol] | X |
| Comparative Example 2 | 0.0 | 4.0 | 1.6 | 180 | [symbol] | X |
| Comparative Example 3 | 0.8 | 0.0 | 2.7 | 490 | X | X |
| Comparative Example 4 | 0.0 | 0.0 | 2.1 | 320 | X | X |
| Comparative Example 5 | 0.8 | 3.5 | 1.5 | 260 | ◯ | X |
| Comparative Example 6 | 0.0 | 3.8 | 1.7 | 190 | [symbol] | X |
| Comparative Example 7 | 0.8 | 0.0 | 2.6 | 480 | X | X |
| Comparative Example 8 | 0.8 | 0.0 | 2.8 | 490 | X | X |

The above results show that an electrode, whether positive or negative, containing the lithium titanate proposed by the present invention will provide a lithium ion secondary battery offering high initial discharge capacity, excellent rate characteristics, and good electrode smoothness.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, an article “a” may refer to a species or a genus including multiple species, and “the invention” or “the present invention” may refer to at least one of the embodiments or aspects explicitly, necessarily, or inherently disclosed herein. In this disclosure, any defined meanings do not necessarily exclude ordinary and customary meanings in some embodiments.

The present application claims priority to Japanese Patent Application No. 2011-225158, filed Oct. 12, 2011, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A ceramic material whose main constituent is a lithium titanate having a spinel structure, containing 0.004 to 0.249 percent by mass of potassium, 0.013 to 0.240 percent by mass of phosphorous and 0.021 to 1.049 percent by mass of niobium.

2. A ceramic material according to claim 1, wherein the peak intensity measured on the Li_{27.84}Ti_{36.816}Nb_{1.344}O₉₀ (310) plane by powder X-ray diffraction is 3/100 of the peak intensity of the Li₄Ti₅O₁₂ (111) plane or less.

3. A ceramic material according to claim 1, wherein the maximum size of the primary particle is 2μm or less.

4. A ceramic material according to claim 2, wherein the maximum size of the primary particle is 2μm or less.

5. A positive electrode for a battery containing the ceramic material according to claim 1 as a positive electrode active material.

6. A positive electrode for a battery containing the ceramic material according to claim 2 as a positive electrode active material.

7. A positive electrode for a battery containing the ceramic material according to claim 3 as a positive electrode active material.

8. A positive electrode for a battery containing the ceramic material according to claim 4 as a positive electrode active material

9. A negative electrode for a battery containing the ceramic material according to claim 1 as a negative electrode active material.

10. A negative electrode for a battery containing the ceramic material according to claim 2 as a negative electrode active material.

11. A negative electrode for a battery containing the ceramic material according to claim 3 as a negative electrode active material.

12. A negative electrode for a battery containing the ceramic material according to claim 4 as a negative electrode active material.

13. A lithium ion secondary battery having:
a positive electrode containing a ceramic material whose main constituent is a lithium titanate having a spinel structure, said ceramic material containing 0.004 to 0.249 percent by mass of potassium, 0.013 to 0.240 percent by mass of phosphorous and 0.021 to 1.049 percent by mass of niobium: or
a negative electrode containing a ceramic material whose main constituent is a lithium titanate having a spinel structure, said ceramic material containing 0.004 to 0.249 percent by mass of potassium, 0.013 to 0.240 percent by mass of phosphorous and 0.021 to 1.049 percent by mass of niobium.

14. A lithium-titanium complex oxide consisting essentially of a lithium titanate having a spinel structure, 0.004 to 0.249 percent by mass of potassium, 0.013 to 0.240 percent by mass of phosphorous, and 0.021 to 1.049 percent by mass of niobium.

15. A granule, paste, or compact containing the lithium-titanium complex oxide according to claim 14 and an auxiliary substance.
